(19) United States
(12) Patent Application Publication
(10) Pub. No.: US 2007/0146651 A1
(43) Pub. Date: Jun. 28, 2007

(54) PROJECTOR WITH ROTATABLE LENS MODULE

(76) Inventors: Hsing-Cheng Lee, Kweishan (TW); Chia-Lin Chang, Kweishan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/423,963

(22) Filed: Jun. 14, 2006

(30) Foreign Application Priority Data
Dec. 23, 2005 (TW) 094145988

(51) Int. Cl. G03B 3/00

(52) U.S. Cl. 353/101

(57) ABSTRACT

A projector with a rotatable lens module is provided in this invention. The projector includes a lens module, a base module, and a connecting module. The connecting module connects the lens module and the base module such that the lens module and the base module are relatively rotatable with each other.

### BACKGROUND OF THE INVENTION

1. Field of the Invention

The invention relates to a projector and, more particularly, to a projector with a rotatable lens module.

2. Description of the Prior Art

In recent years, with the rapid development of consumer electronic products, home theaters have become more and more popular. Because projectors have the merits of occupying less space yet supplying large scale images, many home theaters adopt projectors as displayers. In addition to the projectors, displaying systems using projectors also need to establish projecting screens or find a large blank wall to project images. However, due to the limitation of various space allocation and decoration, not all the places at which the user wants to watch movies have appropriate projecting screens or large blank wall for the projection of images.

Besides, the lamps in some projectors have very high temperature during operation. Because the thermal convection complies with a regular direction, many projectors have an upper and lower bound for the angle in which the projector can be tilted, so as to allow the maximum functioning of the heat-dissipating device, or the lamp may crack due to excessive heat. As a result, the user cannot freely adjust the projecting angle as he wishes.

### SUMMARY OF THE INVENTION

To solve the shortcomings discussed above, the invention provides a projector with a rotatable lens module. The lens of the projector, according to the present invention, can be rotated 360° to overcome the special limitation. The user of the projector can freely choose the place at which he wants to display the images. For example, ceiling usually is the largest blank wall in a room. The user can rotate the projector lens towards the ceiling to project the images on it. In addition, when changing the projecting angle, the projector, according to the present invention, does not need to use the supporter of the projector to adjust the projecting height like the prior art.

The projector, according to the present invention, includes a lens module, a base module, and a connecting module. The connecting module is used for connecting the lens module and the base module, such that the lens module is capable of rotating with respect to the base module.

According to the first preferred embodiment of present invention, the lens module includes an optical device for projecting optical information. The base module includes a light source and a power supply. The light source has an optical axis, and when the lens module rotates with respect to the base module around a rotational axis, the rotational axis is substantially co-axial with the optical axis of the light source.

According to the second preferred embodiment of present invention, the projector includes a lens module, a base module, and a connecting module. The lens module includes an optical device and a light source. The optical device is used for projecting optical information. The light source is used for supplying light to the optical device. The base module includes a power supply for supplying electrical power to the optical device and the light source. The difference between the second and the first preferred embodiment of the present invention is that the light source of this embodiment is included in the lens module capable of rotating with respect to the base module.

The advantage and spirit of the invention may be understood by the following recitations together with the appended drawings.

### BRIEF DESCRIPTION OF THE APPENDED DRAWINGS

FIG. 1 is an outside view of the projector 10 according to the first preferred embodiment of present invention.

FIG. 2 is a perspective view of the projector 10.

### DETAILED DESCRIPTION OF THE INVENTION

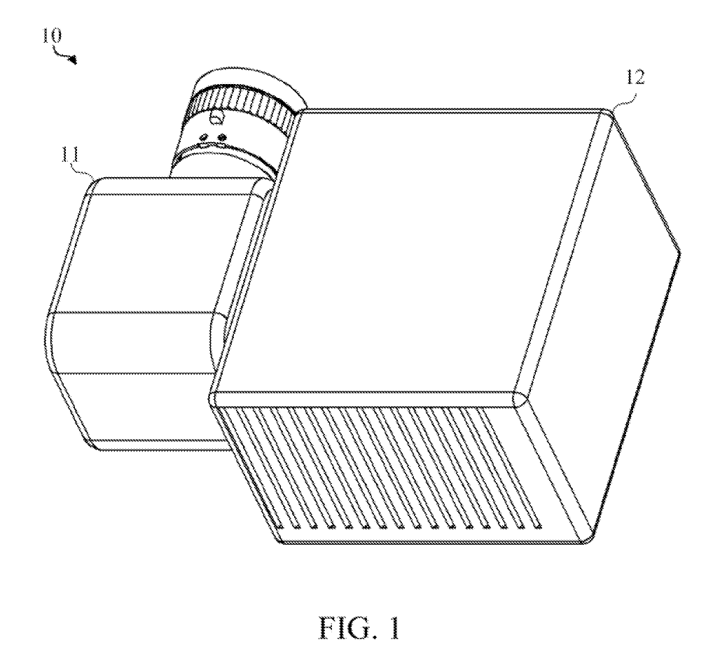

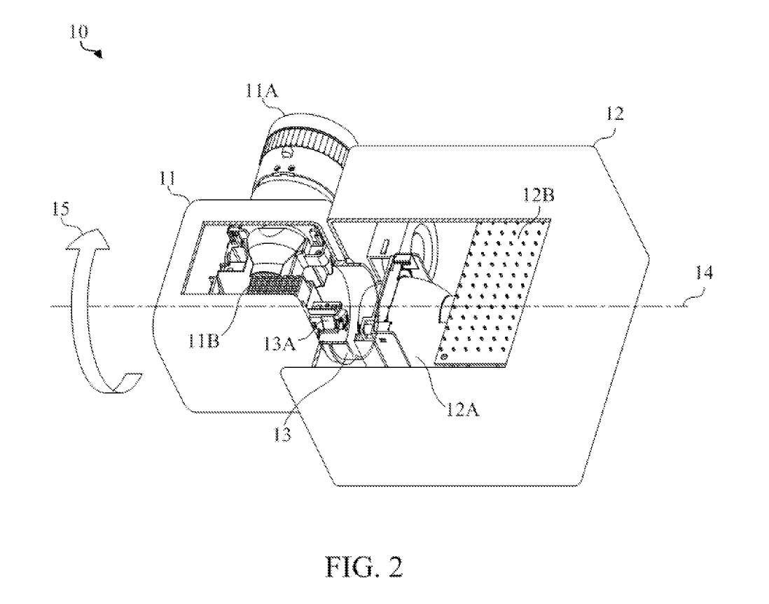

An objective of the invention is to provide a projector with a rotatable lens module. Referring to FIG. 1 and FIG. 2, FIG. 1 is an outside view of the projector 10 according to the first preferred embodiment of present invention. FIG. 2 is a perspective view of the projector 10. The projector 10 includes a lens module 11, a base module 12, and a connecting module 13. The lens module 11 includes an optical device for projecting optical information. The optical device is illustrated as lens 11A and an optical engine 11B shown in FIG. 2, but different kinds of projector may differ in the optical device. The base module 12 includes a light source 12A and a power supply 12B. The light source 12A is used for supplying light to the optical engine 11B and has an optical axis 14. The power supply 12B is used for supplying electrical power to the optical engine 11B and the light source 12A. The connecting module 13 can be a co-axial connector between the lens module 11 and the base module 12 to connect the lens module 11 and the base module 12, so that the lens module 11 can rotate along or against the direction pointed by the arrow 15 with respect to the base module 12. In order to keep the light supplied by the light source 12A entirely projected to the device for receiving light, such as a lens or a reflector, in the optical engine 11B when the lens module 11 rotates, the rotational axis of the lens module 11 is substantially co-axial with the optical axis 14 of the light source 12A. In practical application, the light source 12A generally includes a lamp. The lamp can be an ellipsoid lamp or a lamp with parallel light. If the lamp is an ellipsoid lamp, the connecting module 13 can further includes a light pipe 13A, as shown in FIG. 2. The light supplied by the lamp is focused at the optical center of the light pipe 13A, then scattered to the tube wall around the optical center. Finally, the light is transmitted to the optical engine 11B via the light pipe 13A as parallel light form. As shown in FIG. 2, the light pipe 13A is disposed in the connecting module 13 and positioned along the optical axis 14 of the light source 12A. In addition, the base module 12 further includes a heat-dissipating device (not shown) for dissipating the heat generated by the light source.

The idea and method of present invention can be used in every kind of projector. Therefore, the optical engine 11B can be a digital light processing (DLP) type, a liquid crystal display (LCD) type, or a liquid crystal on silicon (LCOS) type.

From the above recitation, the lamps in some projectors have very high temperature during operation. Because the thermal convection complies with a regular direction, many projectors have a upper and lower bound for the angle in which the projector can be tilted, so as to allow the maximum functioning of the heat-dissipating device, or the lamp may be cracked due to excessive heat. In the present embodiment, the major rotating part in the projector 10 is the lens module 11, so the light source 12A included in the base module 12 can be kept at a fixed position. Therefore, the heat-dissipating condition of the light source 12A will not be affected when the user changes the angle of projection. Thereby, the user can adjust the angle of projecting image to what he wants, and the designer need not adopt extra and complicated heat-dissipating design to correspond with the rotating angle of the lens module 11.

According to the second preferred embodiment of present invention, the projector includes a lens module, a base module, and a connecting module. The lens module includes an optical device and a light source. The optical device is used for projecting optical information. The light source is used for supplying light to the optical device. The base module includes a power supply for supplying electrical power to the optical device and the light source. The connecting module is used for connecting the lens module and the base module, such that the lens module is capable of rotating with respect to the base module. The lens module further includes a heat-dissipating device, if necessary, for dissipating the heat generated by the light source. The difference between the second and the first preferred embodiment of present invention is that the light source of this embodiment is included in the lens module capable of rotating with respect to the base module.

The present embodiment is appropriate for the situation that the heat generated by the light source is low. For example, a projector using an LED lamp as the light source is appropriate for the structure of the present embodiment. Due to the fact that lower temperature is induced during the operation of an LED lamp, changing the direction and the angle of light source will not affect the heat-dissipating efficiency too much as long as an appropriate heat-dissipating device is provided. Therefore, the light source can be included in the lens module. The merit of the present embodiment is that the rotatable direction of the lens module is not necessarily co-axial with the optical axis of the light source. The direction and the angle that the projector can project image becomes more changeable.

Compared to the prior art, the projector lens, according to the present invention, can be rotated 360° to overcome special limitation. For example, the user can rotate the projector lens towards the ceiling to project the image on it and comfortably stay in a lying position to watch the film. Compared to the prior art, the user of the projector can freely choose the place he wants to display the image.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A projector, comprising:
a lens module;
a base module; and
a connecting module for connecting the lens module and the base module such that the lens module is capable of rotating with respect to the base module.

2. The projector of claim 1, wherein the lens module comprises an optical device for projecting optical information.

3. The projector of claim 2, wherein the base module comprises a light source for supplying light to the optical device and a power supply for supplying electrical power to the optical device and the light source.

4. The projector of claim 3, wherein the light source has an optical axis, the lens module is capable of rotating with respect to the base module around a rotational axis, and the rotational axis is substantially co-axial with the optical axis of the light source.

5. The projector of claim 3, wherein the light source comprises a lamp emitting parallel light.

6. The projector of claim 3, wherein the light source comprises an ellipsoid lamp.

7. The projector of claim 6, wherein the connecting module comprises a light pipe for conducting light emitted by the ellipsoid lamp to the optical device, and the light pipe is disposed in the connecting module and positioned along the optical axis of the light source.

8. The projector of claim 3, wherein the base module further comprises a heat-dissipating device for dissipating the heat generated by the light source.

9. The projector of claim 1, wherein the lens module comprises an optical device for projecting optical information and a light source supplying light to the optical device.

10. The projector of claim 9, wherein the base module comprises a power supply for supplying electrical power to the optical device and the light source.

11. The projector of claim 9, wherein the light source comprises an LED lamp.

12. The projector of claim 9, wherein the lens module further comprises a heat-dissipating device for dissipating the heat generated by the light source.

13. The projector of claim 1, wherein the connecting module is a co-axial connector.

14. The projector of claim 1, wherein the optical device is of a digital light processing (DLP) type, a liquid crystal display (LCD) type, or a liquid crystal on silicon (LCOS) type.
